(19) United States
(12) Patent Application Publication
(10) Pub. No.: US 2014/0215835 A1
(43) Pub. Date: Aug. 7, 2014

(54) BATTERY POWERED HAND HELD CUTTING TOOL

(71) Applicants: Mikael Racov, Huskvarna (SE); Henrik Hvitman, Norrahammar (SE)

(72) Inventors: Mikael Racov, Huskvarna (SE); Henrik Hvitman, Norrahammar (SE)

(73) Assignee: HUSQVARNA AB, Huskvarna (SE)

(21) Appl. No.: 14/239,450

(22) PCT Filed: Aug. 26, 2011
(86) PCT No.: PCT/SE2011/051029

§ 371 Date: Feb. 18, 2014

(51) Int. Cl. A01D 34/416

(52) U.S. Cl. CPC A01D 34/416
USPC 30/276

(57) ABSTRACT

A hand held battery powered cutting tool is provided. The tool the (1) comprises a handle portion (30), a cutting assembly (10) which cutting assembly comprises a cutting means carrier (12) arranged to rotate therewith a cutting means (13) about a first axis (A1) of rotation, and an electric motor (11) arranged to rotate an output shaft about a second axis (A2) of rotation. The tool furthermore comprises an elongate rod (20) interconnecting the handle portion (30) and the cutting assembly (10). The elongate rod (20) has a lower end portion (21) arranged proximal to the cutting assembly (10). The lower end portion has an extension direction essentially coinciding with the first axis (A1) of rotation. The second axis (A2) of rotation is located behind the first axis (A1) of rotation when the tool (1) is in a working position.

### TECHNICAL FIELD

The present invention relates to battery powered hand held cutting tools, and in particular to battery powered hand held cutting tools having a cutting assembly in which an electric motor is arranged.

### BACKGROUND OF THE INVENTION

Battery powered hand held cutting tools, such as battery powered grass trimmers, are well known in the art. They generally comprise a cutting assembly and a handle portion. An elongate rod or tube interconnects the cutting assembly and the handle portion so as to position the cutting assembly at a convenient distance from the handle portion.

There remains a need for an improved battery powered hand held cutting tool which is comfortable to use, and which is easy to maneuver. The cutting tool should preferably be robust, and possible to manufacture at a low cost.

### SUMMARY OF THE INVENTION

It is an object of the present invention to provide a battery powered hand held cutting tool which is comfortable to use, and easy to maneuver. The cutting tool should preferably be robust and possible to manufacture at a low cost.

According to an aspect of the solution, this object is at least partly achieved by means of a hand held battery powered cutting tool comprising a handle portion, a cutting assembly, which cutting assembly comprises a cutting means carrier arranged to rotate therewith a cutting means about a first axis of rotation, and an electric motor arranged to rotate an output shaft about a second axis of rotation. An elongate rod interconnects the handle portion and the cutting assembly, so as to position the cutting assembly at a convenient distance from the handle portion. The cutting tool is characterized in that the elongate rod has a lower end portion arranged proximal to the cutting assembly, which lower end portion has an extension direction essentially coinciding with the first axis of rotation; and in that the second axis of rotation is located behind the first axis of rotation when the tool is in a working position.

By positioning the electric motor behind the lower end portion of the elongate rod an advantageous distribution of masses within the tool is achieved, such that an ergonomically profitable design of the tool is facilitated. Thereby, usage of the tool is simplified and operator fatigue may be reduced.

When the electric motor is positioned behind the lower end portion of the elongate rod, it does not obstruct the operator's view of the front side of the cutting assembly, as it would have done if it would have been positioned in front of the lower end portion of the elongate rod.

By configuring the tool such that the extension direction of the lower end portion of elongate rod essentially coincides with the axis of rotation of the cutting means carrier and the cutting means, it becomes easy and intuitive for an operator of the tool to know where a cutting action is performed even if the cutting means carrier and the cutting means are hidden.

This configuration also provides a cutting tool which is easy and simple to manufacture at a low cost.

According to an embodiment of the solution, the first and second axes of rotation are substantially parallel. Thereby, power transmission from the electric motor to the cutting means carrier can be arranged in a simple and cost efficient way.

According to another embodiment, the elongate rod has a curved configuration. Thereby, a proper cutting angle is easy to combine with a comfortable working position of the operator.

According to yet another embodiment, the lower end portion of the elongate rod extends into the cutting assembly such that an orthogonal projection of the electric motor on the first axis of rotation at least partially overlaps the lower end portion of the elongate rod. Thereby, a robust construction is achieved.

According to another embodiment, the handheld battery powered cutting tool is a grass trimmer.

According to another embodiment, a gear reduction stage is provided between the electric motor and the cutting means carrier.

According to another embodiment the gear reduction stage comprises a belt drive arrangement. Thereby, the sound level of the tool can be kept low.

According to yet another embodiment the gear reduction stage comprises a gear wheel arrangement.

### DEFINITIONS

As used herein the following terms have the following meanings:

The forward and backward directions are defined based on how an operator, holding the tool in a normal working position would see these directions.

The terms upwards, downwards, lower and upper, are also defined based on how an operator holding the tool in a normal working position would see these directions.

### BRIEF DESCRIPTION OF THE DRAWINGS

The invention will be understood and appreciated more fully from the following detailed description, taken in conjunction with the drawings, in which:

FIG. 1 is a perspective view of a battery powered hand held cutting tool, according to an embodiment of the invention,

FIG. 2 is a side view of a cutting assembly of the cutting tool in FIG. 1;

FIG. 3 is a cross sectional view of the cutting assembly shown in FIG. 2.

### DESCRIPTION OF PREFERRED EMBODIMENTS

The present invention will be described more fully hereinafter with reference to the accompanying drawings, in which preferred embodiments of the invention are shown. The invention may, however, be embodied in many different forms and should not be construed as limited to the embodiments set forth herein; rather these embodiments are provided so that this disclosure will be thorough and complete, and will fully convey the scope of the invention to those skilled in the art. In the drawings, like numbers refer to like elements.

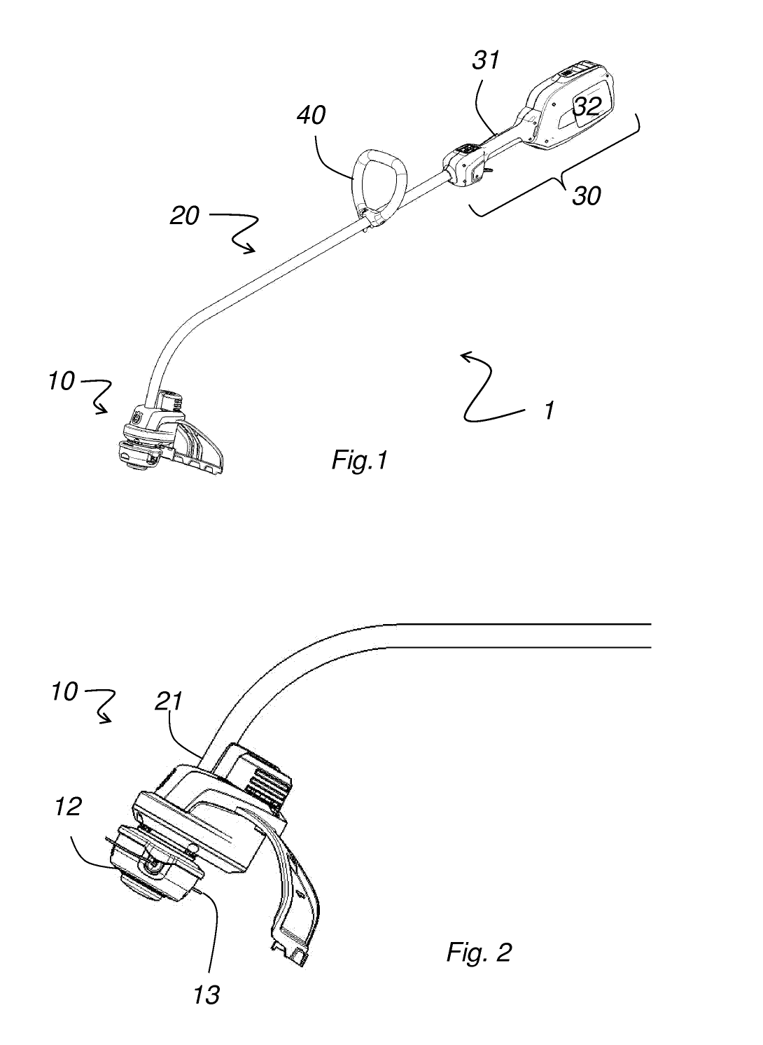

Referring to FIGS. 1 and 2, a battery powered hand held cutting tool 1 embodied as a grass trimmer 1 is shown. The trimmer 1 has a handle portion 30, comprising a rear handle 31 and a battery pack compartment 32.

The grass trimmer also comprises a cutting assembly 10.

An elongate rod 20 or tube 20 interconnects the handle portion and the cutting assembly. According to the embodiment shown in FIG. 1, the rod 20 has a curved configuration.

A supplementary handle 40 may be provided in front of the handle portion.

A lower end portion 21 of the rod 20 is connected to the cutting assembly 10.

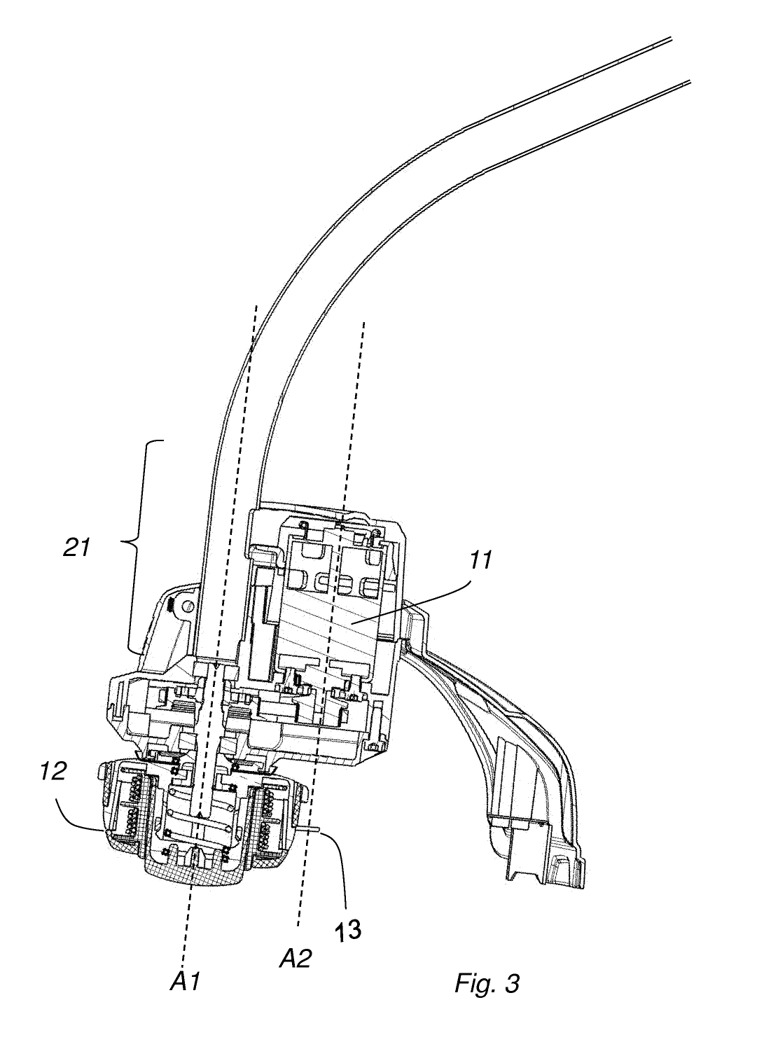

The cutting assembly 10 comprises a cutting means carrier 12 which may also be referred to as a cutting head 12. A cutting means 13, such as a trimmer line or knife is connected to the cutting means carrier, so as to rotate with the cutting means carrier about a first axis A1 of rotation, as shown in FIG. 3.

An electric motor 11 is also arranged in the cutting assembly. According to an embodiment, the motor is a PMDC motor. The electric motor forces the cutting means carrier to rotate about a first axis A1 of rotation.

The output shaft of the motor rotates about a second axis A2 of rotation. The electric motor is energized by a battery pack arranged in the battery pack compartment 32. A gear reduction stage may be provided between the electric motor and the cutting means carrier. The gear reduction stage may comprise a belt drive arrangement or a gear wheel arrangement.

The lower end portion 21 of the elongate rod 20 is connected to the cutting assembly such that its extension direction essentially coincides with the first axis A1 of rotation.

When an operator holds the grass trimmer in a normal working position, the second axis A2 of rotation is arranged behind the first axis A1 of rotation.

The cutting tool may be configured such that the first and second axes of rotation are essentially parallel. However, other configurations are also possible.

According to the embodiment shown in FIG. 3, the elongate rod extends relatively deeply into the cutting assembly. In this way a robust connection between the cutting assembly and the elongate rod is achieved.

In the drawings and specification, there have been disclosed preferred embodiments and examples of the invention and, although specific terms are employed, they are used in a generic and descriptive sense only and not for the purpose of limitation, the scope of the invention being set forth in the following claims.

1. A hand held battery powered cutting tool, the tool comprising:
a handle portion;
a cutting assembly, the cutting assembly comprising a cutting means carrier arranged to rotate therewith a cutting means about a first axis of rotation, and an electric motor arranged to rotate an output shaft about a second axis of rotation;
an elongate rod interconnecting a handle portion and the cutting assembly, so as to position the cutting assembly at a convenient distance from the handle portion,
wherein the elongate rod has a lower end portion arranged proximal to the cutting assembly, the lower end portion having an extension direction essentially coinciding with the first axis of rotation; and
wherein the second axis of rotation is located behind the first axis of rotation when the tool is in a working position.

2. A hand held battery powered tool according to claim 1, wherein the first and second axes of rotation are substantially parallel.

3. A hand held battery powered tool according to claim 1, wherein the elongate rod has a curved configuration.

4. A hand held battery powered tool according to claim 1, wherein the lower end portion of the elongate rod extends into the cutting assembly such that an orthogonal projection of the electric motor on the first axis of rotation at least partially overlap the lower end portion of the elongate rod.

5. A hand held battery powered tool according to claim 1, wherein the tool is a battery powered grass trimmer.

6. A hand held battery powered tool according to claim 1, wherein a gear reduction stage is provided between the electric motor and the cutting means carrier.

7. A hand held battery powered tool according to claim 6, wherein the gear reduction stage comprises a belt drive arrangement.

8. A hand held battery powered tool according to claim 6, wherein the gear reduction stage comprises a gear wheel arrangement.
